(19) United States
(12) Patent Application Publication
(10) Pub. No.: US 2007/0080480 A1
(43) Pub. Date: Apr. 12, 2007

(54) Method for reducing the allergenic protein content of natural rubber latex articles

(76) Inventors: Rick Tabor, Glenview, IL (US); James Hartlage, Chicago, IL (US)

Correspondence Address: MCANDREWS HELD & MALLOY, LTD, 500 WEST MADISON STREET, SUITE 3400, CHICAGO, IL, 60661, US

(21) Appl. No.: 10/546,677

(22) PCT Filed: Feb. 20, 2004
(86) PCT No.: PCT/US04/05198

§ 371 Date: Dec. 6, 2006

(30) Foreign Application Priority Data
Mar. 3, 2003 (US) 60451482

(51) Int. Cl. B29C 41/14

(52) U.S. Cl. 264/232; 264/301; 264/233; 264/234

(57) ABSTRACT

The present invention provides a method of reducing and/or neutralizing the allergenic protein content of natural rubber latex articles by exposing the natural rubber latex from which the article is made or the final natural rubber latex to an allergenic protein reducing compound. The allergenic protein reducing compounds for use in the present invention fall generally into two classes: (1) cationic compounds and (2) nitrogen-containing compounds. Quaternary ammonium salts are particularly preferred allergenic protein reducing compounds.

### RELATED APPLICATIONS

This application claims priority to U.S. Provisional Application Ser. No. 60/451,482, filed Mar. 3, 2003.

### BACKGROUND OF THE INVENTION

Natural rubber latex (NRL) is used for a variety of applications, including exam gloves, surgical gloves, catheters, tubing and condoms. Due to concerns about AIDS and other blood and fluid borne diseases, the rubber glove market in recent years has experienced high growth. Natural rubber is obtained in latex form from the milky sap (latex) of the tree Hevea Brasiliensis. The natural rubber latex products industry is presently in the midst of a paradigm shift, because the endogenous proteins in inexpensive NRL cause allergic reactions in about 8% of the population, including itching or burning skin, rashes, asthma and even anaphylactic shock in both medical professionals and their patients (Annals of Emergency Medicine 2002; 40:411-419). Exam gloves are being developed from much more expensive synthetic polymers in order to avoid this problem, but these polymers, thus far, are deficient with respect to their tensile, elongation and “comfort” properties. Natural rubber elongates to between 4-900% at very low strain and then stress crystallizes to provide high ultimate tensile strength. This property of natural rubber is difficult to achieve using synthetic polymers, and allows for a high degree of comfort in natural rubber gloves.

Efforts to eliminate the endogenous proteins have included chlorination of the latex and treatment with enzymes to cleave the proteins to lower, less allergenically active, molecular weights. These approaches have allowed for reduction of the protein content of current latex products, but they have not eliminated the protein problem. (For further background see: U.S. Pat. No. 5,777,004: “Method of neutralizing protein allergens in natural rubber latex product formed thereby”; and U.S. Pat. No. 5,563,241: “Methods to remove proteins from natural rubber latex”).

### BRIEF SUMMARY OF THE INVENTION

The present invention relates to reducing and/or neutralizing the allergenic protein content of natural rubber latex articles. In particular, the present invention provides a method to reduce and/or neutralize the allergenic protein content of NRL by introducing an allergenic protein reducing compound into one of various stages in the manufacture of an article made of NRL. The method of the present invention is particularly applicable to NRL articles that are made through a dipping process. The allergenic protein reducing compounds for use with the method of the present invention may include quatemary ammonium salts, tertiary ammonium salts, secondary ammonium salts, primary ammonium salts, ammonium salts, sulfobetaines, betaines, pyridinium salts, nitrogen-containing heterocyclic amine salts, amino carboxylates, amine oxides, amides, nitrogen-containing heterocyclic amides, and polyvinyl pyrrolidone.

Many NRL articles are made using multi-staged dipping processes that may include holding the NRL in a tank, dipping a former into one or more NRL dipping tanks so that the former is covered with the NRL to make an article in the shape of the former, heating the NRL covered former so that the NRL film may dry into a pre-cured film, passing the formers through pre-vulcanization leaching tanks to remove excess chemical residue and latex protein with hot water; passing the former through a vulcanization stage; passing the former through a post-vulcanization leaching tank to remove more latex protein and chemical residue; removal of the formed article from the former; laundering the formed articles in a washing step; and finally drying the formed articles and optionally packaging them for shipment.

The allergenic protein reducing compounds for use in the present invention may be employed in the NRL holding tank, the dipping tanks, any of the leaching tanks, the vulcanization stage, the laundering stage or any combination of these stages. The allergenic protein reducing compound may also be employed in the final drying stage by introduction as a vapor or aerosol, for example, via the use of dryer sheets coated with the allergenic protein reducing compound.

### DETAILED DESCRIPTION OF THE INVENTION

The method of the present invention includes exposing either a natural rubber latex or a natural rubber latex article to an allergenic protein reducing compound. This exposure reduces and/or neutralizes the allergenic protein content of the natural rubber latex articles.

One typical method of making NRL articles is a dipping process. Formers are provided in the shape of a desired article, for example in the shape of a hand for making NRL exam or surgical gloves. These formers may be first washed in hot water to clean the formers. The formers are then typically dipped into a coagulant tank that contains an aqueous solution of calcium nitrate. The formers may then be dipped in a tank holding NRL where the calcium on the surface of the former coagulates a thin layer of gel onto the former. The formers are then passed through an oven where the coagulated latex dries into a pre-cured film.

The formers are then passed through pre-vulcanization leaching tanks to remove excess chemical residue and latex protein with hot water. Any number of pre-vulcanization leaching tanks may be used. A typical arrangement includes 3 long pre-vulzanization leaching tanks instead of just a single leaching tank, because multiple leaching tanks ensure the maximum removal of latex protein and chemical residue from the latex gel film on the formers. The extraction of the latex proteins and chemical residues is further enhanced by employing hot water, counter-flowing continuously against the formers as they pass through the pre-vulcanization leaching tanks.

The next step is typically passing the formers into the vulcanization oven to be heated to remove moisture from the latex gel and harden the latex gel. The formers may then be passed through a post-vulcanization leaching tank to remove more latex protein and chemical residue. The post-vulcanization leaching tank is considered by some to be the most important step in removing excess latex protein from the NRL articles.

The formers may then be passed into another oven for further drying. The formers may then be passed into another tank containing wet cornstarch powder and water. After another drying oven, the articles may be stripped from the formers either by hand one at a time or by an automatic air ejection machine. The articles may then be placed into tumble dryers for the final vulcanization process.

The method of the present invention involves exposing the NRL or NRL articles with an allergenic protein reducing compound or compounds in an amount sufficient to effectively reduce and/or neutralize the allergenic protein content of the natural rubber latex articles. The allergenic protein reducing compound or compounds may be employed at any number of the steps in the making of the NRL articles. The allergenic protein reducing compounds for use with the method of the present invention may include quaternary ammonium salts, tertiary ammonium salts, secondary ammonium salts, primary ammonium salts, ammonium salts, sulfobetaines, betaines, pyridinium salts, nitrogen-containing heterocyclic amine salts, amino carboxylates, amine oxides, amides, nitrogen-containing heterocyclic amides, and polyvinyl pyrrolidone. The allergenic protein reducing compounds for use in the present invention fall generally into two classes: (1) cationic compounds and (2) nitrogen-containing compounds.

The preferred allergenic protein reducing compounds are quaternary ammonium salts. Quaternary ammonium salts have been used in the past in conditioner applications. For example, quaternary ammonium salts have been found to bind to the external surfaces of hair proteins via Lewis acid/Lewis base complexation. This binding changes the surface chemistry of the hair from protein-like to hydrocarbon-like. The quaternary ammonium salts may be used in the method of the present invention in a similar manner and it is believed that they neutralize the latex proteins in NRL articles by permitting the quaternary ammonium salts to complex with the latex proteins to change the surface chemistry of the NRL article from protein-like to hydrocarbon-like.

The other identified allergenic protein reducing compounds (i.e., other than the quaternary ammonium salts) have similarly provided changes in surfaces from protein-like to hydrocarbon-like, and it is believed that they would provide the same benefits to NRL articles.

It is anticipated that the efficacy of the allergenic protein reducing compounds will be improved in combination with other additives such as, for example, surfactants, pH controllers, buffers, emulsifiers, viscosity modifiers, inorganic salts, waxes, alcohols, and preservatives.

As noted above, the allergenic protein reducing compound, preferably quaternary ammonium salt, may be employed in any of several steps in the making of the NRL article. For example, the allergenic protein reducing compounds for use in the present invention may be employed in the NRL holding tank, the dipping tanks, any of the leaching tanks, the vulcanization stage, the laundering stage or any combination of these stages. The allergenic protein reducing compound or compounds should be present in an amount sufficient to effectively reduce and/or neutralize the allergenic protein content of the natural rubber latex articles, preferably equal to or greater than 0.01 weight percent based on the weight of the natural rubber latex to be treated. Those skilled in the art will understand that both water and other media, e.g. alcohol, may be used with the allergenic protein reducing compound or compounds identified for use in the present invention.

The allergenic protein reducing compound may also be employed in the final drying stage by introduction as a vapor or aerosol, for example, via the use of dryer sheets coated with the allergenic protein reducing compound in an amount effective to reduce and/or neutralize the allergenic protein content of the natural rubber latex articles, preferably in a concentration equal to or greater than 0.01 weight percent based on the weight of the natural rubber latex to be treated.

The following examples demonstrate the effectiveness of reducing and/or neutralizing the latex proteins of NRL articles.

### EXAMPLE 1

Two commercially available natural rubber latex gloves were shaken in 50° C. water containing either Ammonyx SDBC (61.9% stearamidopropalkonium chloride/22% isopropanol/13.7% water/2.4% of a mixture of N,N-dimethyl stearamidopropylarnine and its hydrochloride salt; commercially available from Stepan Company, Northfield, Ill.), Quaternary Amine Formulation, or no additive in a quart bottle for 5 minutes. The additives were added at a level of 25 g of additive per 500 g of water. The gloves were then allowed to drip/air dry and tested pursuant to ASTM D6499-00 Inhibition ELISA protein content test (which uses rabbit antigens to determine specifically the NRL allergenic protein content).

| | | D6499 Inhibition |
|---|---|---|
| | | ELISA protein |
| Sample | Treatment Type | (microgram/gram) |
| A | None | 8.4 |
| B | Quaternary Amine | 1.3 |
| | Formulation | |
| C | Ammonyx SDBC | 2.1 |

Quaternary Amine Formulation is Redken Allsoft dry/brittle hair conditioner, having a measured solids content of 16.0% by weight. The ingredients of the Redken Conditioner are as follows, the first five listed ingredients being cationic allergenic protein reducing compounds providing the benefits of the present invention:

behenalkonium chloride

disodium cocoamphodipropionate

arginine hydrochloride

guar hydroxypropyl trimonium chloride

cetrimonium chloride

water

cetearyl alcohol

glycerin

propylene glycol deteth-3-acetate

cyclomethicone

cetyl alcohol

lecithin

PPG-f-ceteth-20

oleth-10

avocado oil

taurine

hydrolyzed soy protein

wheat amino acids

hydroxypropyl-tromonium hydrolyzed wheat protein

trehalose disodium EDTA

ethyl paraben

methyl paraben

guar hydroxypropyl trirnonium chloride

phenoxy ethanol

glyceryl stearate

PEG-100 stearate

cetrimonium chloride

propylparaben

dimethicone

D&C Orange #4

FD&C Yellow #%

fragrance.

As is evident from Example 1, the use of the stearamidopropalkonium chloride and Quaternary Amine Formulation greatly reduces and/or neutralizes the NRL allergenic protein content as measured by ASTM D6499-00 Inhibition ELISA protein content test.

### EXAMPLE 2

Two sets of 2 commercially available, natural rubber latex gloves each were stirred in 400 grams of 50° C. water for 24 hours—one with Quaternary Amine Formulation (chosen due to the slightly better results as shown in Example 1, above) and one with pure water. The additive was added in an amount of 25 g/400 g of water. The results of the allergenic protein content analysis are summarized in the table below:

| | | D6499 Inhibition |
|---|---|---|
| | | ELISA protein |
| Sample | Treatment Type | (microgram/gram) |
| D | None | 2.7 |
| E | Quaternary Amine | <0.3 (non-detectable) |
| | Formulation | |

As is evident from Example 2, the Quaternary Amine Formulation (Redken Conditioner) effectively reduces and/or neutralizes the NRL allergenic protein content of NRL articles.

Additionally, the resulting latex rubber films described by Samples B, C and E had a non-tacky powdery “feel” between the polymer surfaces, suggesting that the composition may be utilized in non-tacking, easily donned exam or surgical gloves.

The invention has been described with reference to preferred and alternate embodiments. Modifications and alterations will occur to others upon the reading and understanding of the specification. It is intended to include all such modifications and alterations insofar as they come within the scope of the appended claims or equivalents thereof.

1. A method for reducing and/or neutralizing the allergenic protein content of a dip manufactured natural rubber latex article comprising exposing the natural rubber latex, former, and/or formed article to an allergenic protein reducing compound during dip manufacturing of the article.

2. The method of claim 1, wherein the allergenic protein reducing compound is selected from the group consisting of quaternary ammonium salts, tertiary ammonium salts, secondary ammonium salts, primary ammonium salts, ammonium salts, sulfobetaines, betaines, pyridinium salts, nitrogen-containing heterocyclic amine salts, amino carboxylates, amine oxides, amides, nitrogen-containing heterocyclic amides, and polyvinyl pyrrolidone and mixtures thereof.

3. The method of claim 2, wherein a surfactant or surfactant blend is utilized in addition to the allergenic protein reducing compound.

4. The method of claim 2, wherein the allergenic protein reducing compound is a quaternary ammonium salt.

5. A method of reducing and/or neutralizing the allergenic protein content of natural rubber latex articles comprising:
holding natural rubber latex in a holding tank;
dipping a former into the natural rubber latex holding tank so that the former is covered with the natural rubber latex to make a formed article in the shape of the former;
heating the natural rubber latex covered former so that the natural rubber latex film may dry into a pre-cured film;
passing the formers through at least one pre-vulcanization leaching tank to remove excess chemical residue and latex protein with hot water;
passing the former through a vulcanization stage;
passing the former through a post-vulcanization leaching tank to remove more latex protein and chemical residue;
removal of the formed article from the former;
laundering the formed articles in a washing step;
drying the formed articles; and
exposing the natural rubber latex, former; and/or formed article to an allergenic protein reducing compound in any one or more of the previous steps.

6. A method of reducing and/or neutralizing the allergenic protein content of natural rubber latex articles comprising:
holding natural rubber latex in a holding tank;
dipping a former into the natural rubber latex holding tank so that the former is covered with the natural rubber latex to make a formed article in the shape of the former;
heating the natural rubber latex covered former so that the natural rubber latex film may dry into a pre-cured film;
passing the formers through at least one pre-vulcanization leaching tank to remove excess chemical residue and latex protein with hot water;
passing the former through a vulcanization stage;
passing the former through a post-vulcanization leaching tank to remove more latex protein and chemical residue;
removal of the formed article from the former;
laundering the formed articles in a washing step;
drying the formed articles; and
exposing the natural rubber latex, former; and/or formed article to a cationic allergenic protein reducing compound in any one or more of the previous steps.

7. A method of reducing and/or neutralizing the allergenic protein content of natural rubber latex articles comprising:
holding natural rubber latex in a holding tank;
dipping a former into the natural rubber latex holding tank so that the former is covered with the natural rubber latex to make a formed article in the shape of the former;
heating the natural rubber latex covered former so that the natural rubber latex film may dry into a pre-cured film;
passing the formers through at least one pre-vulcanization leaching tank to remove excess chemical residue and latex protein with hot water;
passing the former through a vulcanization stage;
passing the former through a post-vulcanization leaching tank to remove more latex protein and chemical residue;
removal of the formed article from the former;
laundering the formed articles in a washing step;
drying the formed articles; and
exposing the natural rubber latex, former; and/or formed article to an ammonium salt allergenic protein reducing compound in any one or more of the previous steps.

8. A method of reducing and/or neutralizing the allergenic protein content of natural rubber latex articles comprising:
holding natural rubber latex in a holding tank;
dipping a former into the natural rubber latex holding tank so that the former is covered with the natural rubber latex to make a formed article in the shape of the former;
heating the natural rubber latex covered former so that the natural rubber latex film may dry into a pre-cured film;
passing the formers through at least one pre-vulcanization leaching tank to remove excess chemical residue and latex protein with hot water;
passing the former through a vulcanization stage;
passing the former through a post-vulcanization leaching tank to remove more latex protein and chemical residue;
removal of the formed article from the former;
laundering the formed articles in a washing step;
drying the formed articles; and
exposing the natural rubber latex, former; and/or formed article to a quaternary ammonium salt allergenic protein reducing compound in any one or more of the previous steps.

9. A method of reducing and/or neutralizing the allergenic protein content of natural rubber latex articles comprising:
providing a natural rubber latex article;
providing an allergenic protein reducing compound;
exposing the natural rubber latex article to the allergenic protein reducing compound.

10. A method of reducing and/or neutralizing the allergenic protein content of natural rubber latex articles comprising:
providing a natural rubber latex article;
providing a cationic allergenic protein reducing compound;
exposing the natural rubber latex article to the cationic allergenic protein reducing compound.

11. A method of reducing and/or neutralizing the allergenic protein content of natural rubber latex articles comprising:
providing a natural rubber latex article;
providing a quaternary ammonium salt allergenic protein reducing compound;
exposing the natural rubber latex article to the quaternary ammonium salt allergenic protein reducing compound.

12. The method of claim 9, wherein the step of exposing the natural rubber latex article comprises washing the natural rubber latex article in a solution including the allergenic protein reducing compound.

13. The method of claim 10, wherein the step of exposing the natural rubber latex article comprises washing the natural rubber latex article in a solution including the cationic allergenic protein reducing compound.

14. The method of claim 11, wherein the step of exposing the natural rubber latex article comprises washing the natural rubber latex article in a solution including the quaternary ammonium salt allergenic protein reducing compound.

15. The method of claim 9, wherein the step of exposing the natural rubber latex article comprises drying the natural rubber latex article in the presence of dryer sheets coated with the allergenic protein reducing compound.

16. The method of claim 10, wherein the step of exposing the natural rubber latex article comprises drying the natural rubber latex article in the presence of dryer sheets coated with the cationic allergenic protein reducing compound.

17. The method of claim 11, wherein the step of exposing the natural rubber latex article comprises drying the natural rubber latex article in the presence of dryer sheets coated with the quaternary ammonium salt allergenic protein reducing compound.

18. A method for reducing and/or neutralizing the allergenic protein content of a dip manufactured natural rubber latex article comprising exposing the natural rubber latex, former, and/or formed article to an allergenic protein reducing compound, in an amount sufficient to effectively reduce and/or neutralize the allergenic protein content of the natural rubber latex articles, during dip manufacturing of the article.

19. The method of claim 11, wherein the concentration of the allergenic protein reducing compound is equal to or greater than 0.01 weight percent based on the natural rubber latex, and/or formed article to be treated.

20. A reduced allergenic protein natural rubber latex article produced by the method of claim 1.

21. The reduced allergenic protein natural rubber latex article of claim 20 configured to exhibit reduced tackiness compared to an untreated natural rubber latex article.

22. The reduced allergenic protein natural rubber latex article of claim 20, wherein the reduced allergenic protein natural rubber latex article is an exam or surgical glove configured to exhibit improved wet or dry donnability compared to an untreated natural rubber latex exam or surgical glove.

23. A reduced allergenic protein natural rubber latex article produced by the method of claim 9.

24. The reduced allergenic protein natural rubber latex article of claim 23, configured to exhibit reduced tackiness compared to an untreated natural rubber latex article.

25. The reduced allergenic protein natural rubber latex article of claim 23, herein the reduced allergenic protein natural rubber latex article is an exam or surgical glove configured to exhibit improved wet or dry donnability compared to an untreated natural rubber latex exam or surgical glove.
